(19) United States
(12) Patent Application Publication
(10) Pub. No.: US 2018/0123693 A1
(43) Pub. Date: May 3, 2018

(54) OPTICAL DEVICE AND OPTICAL MODULE

(71) Applicant: HUAWEI TECHNOLOGIES CO., LTD., Shenzhen (CN)

(72) Inventor: Sulin YANG, Shenzhen (CN)

(21) Appl. No.: 15/845,909

(22) Filed: Dec. 18, 2017

Related U.S. Application Data
(63) Continuation of application No. PCT/CN2015/082257, filed on Jun. 24, 2015.

(51) Int. Cl. H04B 10/2581; H04J 14/04; G02B 6/02; G02B 6/42; G02B 6/036

(52) U.S. Cl. CPC H04B 10/2581; H04J 14/04; G02B 6/036; G02B 6/4246; G02B 6/02042

(57) ABSTRACT

An optical device (501) is disclosed, including a spatial multiplexer/demultiplexer (520) and an optical splitter (510). The optical splitter (510) is an M:N optical splitter, M is greater than or equal to 2, and N is greater than or equal to M. M is a quantity of common ports of the optical splitter (510), and N is a quantity of drop ports of the optical splitter (510). The spatial multiplexer/demultiplexer (520) includes one common port (521) and M drop ports (522-1 to 522-M). The M drop ports of the spatial multiplexer/demultiplexer (520) are connected to the M common ports of the optical splitter (510). The common port (521) of the spatial multiplexer/demultiplexer (520) has a capability of transmitting optical signals in multiple spatial modes.

### CROSS-REFERENCE TO RELATED APPLICATIONS

This application is a continuation of International Application No. PCT/CN2015/082257, filed on Jun. 24, 2015, the disclosure of which is hereby incorporated by reference in its entirety.

### TECHNICAL FIELD

The present invention relates to the field of optical communications, and in particular, to an optical device and an optical module.

### BACKGROUND

With growing bandwidth requirements of users and support from broadband strategies of governments in countries, a large quantity of passive optical networks (PONs) are deployed all over the world.

Generally, as shown in FIG. 1, a passive optical network system includes one optical line terminal (OLT) 110 located in a central office, multiple optical network units (ONU) or Optical Network Terminal (ONT) 120 located on a user side, and one optical distribution network (ODN) 130 used to split or multiplex/demultiplex optical signals between the optical line terminal and the optical network units. The optical line terminal 110 and the optical network units 120 perform upstream/downstream data receiving/sending by using optical transceiver modules 112 and 123 (or referred to as data transceiver optical modules or referred to as optical modules) or pluggable optical transceiver modules (or referred to as data transceiver optical modules or referred to as optical modules) disposed inside the optical line terminal 110 and the optical network units 120. A downstream direction is from the OLT to the ONUs, and an upstream direction is from the ONUs to the OLT. A signal sent from the OLT to an ONU is a downstream signal, and a signal sent from an ONU to the OLT is an upstream signal. The ODN 123 includes one or more power splitters (Power Splitter, Splitter for short) or optical splitters 131 and 132. The ODN 123 is a star network, and generally includes two stages of optical splitters, including one first-stage optical splitter 131 and multiple second-stage optical splitters 132. The optical splitters 131 and 132 are generally 1:N or 2:N optical splitters (N is generally 2, 4, 6, 8, 16, . . . ). When the ODN 123 performs two-stage splitting, a common port of the first-stage optical splitter 131 is connected to the OLT 110 by using a feeder fiber (Feeder Fiber, FF) 133, drop ports of the first-stage optical splitter 131 are connected to common ports of the second-stage optical splitters 132 by using distribution fibers (DF) 134, and drop ports of the second-stage optical splitter 132 are connected to the ONUs 120 by using drop fibers 135. In an existing system, the fibers 133, 134, and 135 are single-mode fibers that conform to the G.652 or G.657 standard. When the ODN 123 performs one-stage splitting, a common port of an optical splitter is connected to the OLT by using a feeder fiber, and drop ports of the optical splitter are connected to the ONUs by using drop fibers. FIG. 2 is a schematic structural diagram of a 2:N (N=8) splitter in the prior art. The 2:8 optical splitter 200 includes one 2:2 optical splitter 211 and six 1:2 optical splitters 221 to 222 and 231 to 234 that are cascaded. When signals that are input from two common ports 201 and 201′ of the optical splitter 200 pass through the optical splitter 200 and then reach 231-1, 231-2, . . . , 234-1, and 234-2, optical power is reduced to 1/N. When an optical signal that is input from any drop port 231-1, 231-2, . . . , 234-1, or 234-2 passes through the optical splitter 200 and reaches the common ports 201 and 201′, optical power is reduced to 1/N. When the optical splitter 200 has only one common port, assumed to be the common port 201, an optical signal passing through the optical splitter is also reduced to 1/N, that is, 3*log2N dB is attenuated or an insertion loss of the optical splitter is 3*log₂^{N} dB. During actual application, another loss in the optical splitter is considered. Generally, 3.5*log₂^{N} dB is used to calculate the insertion loss of the optical splitter. N is a split ratio of the optical splitter. Another existing optical splitter is shown in FIG. 3. A 1:N optical splitter 301 (N=8 herein) directly includes a 1:8 optical splitter. A loss between a common port 311-1 and drop ports 312-1 to 312-8 or an insertion loss of the optical splitter is 3.5*log₂^{N} dB. The existing power distribution optical splitter has a basically same optical signal loss or insertion loss in the two directions. In the downstream direction, because an optical signal sent by the OLT needs to be broadcast to all the ONUs, a 3.5*log₂^{N} dB loss is introduced when the downstream optical signal passes through the optical splitter. An upstream optical signal sent by an ONU is also attenuated by 3.5*log₂^{N} dB when passing through the optical splitter, that is, (N−1)/N of optical power of the upstream optical signal is lost or wasted by the optical splitter.

In an existing PON network, a function block diagram of an optical module is shown in FIG. 4. The optical module 401 includes a transmitter optical subassembly (TOSA) 411, a receiver optical subassembly (ROSA) 421, a filter (wavelength-division multiplexing (WDM) Filter) 431, an optical interface 441, a ceramic ferrule 451, a receiver circuit 471, and a transmitter circuit 461. There is a single-mode fiber in a cavity of the ceramic ferrule. An optical signal sent by the TOSA passes through the filter 431, then flows into the single-mode fiber in the cavity of the ceramic ferrule, and then connects to the feeder fiber by using the optical interface. An upstream signal passes through the fiber in the cavity of the ceramic ferrule, and then reaches the filter 431 and is reflected to the ROSA 421. The ROSA 421 converts the received upstream optical signal into an electrical signal, and transfers the electrical signal to the receiver circuit 471 for subsequent processing.

In the PON network, time division multiplexing (TDM) is performed in the downstream direction, and time division multiplexing access (TDMA) is performed in the upstream direction. In the downstream direction, the ONUs continuously receive optical signals of the OLT. In the upstream direction, upstream bandwidth of each ONU is authorized by the OLT, and the ONU sends an upstream optical signal only in an authorized timeslot. Therefore, the optical module of the OLT needs to have a burst receiving capability. An increase in a data rate is accompanied with a greater technical challenge and higher costs in improving the burst receiving sensitivity of the optical module of the OLT. Prosperity of services such as video surveillance, smart home, and cloud storage is accompanied with higher requirements of users on upstream bandwidth, and the users are predicted to need upstream bandwidth higher than downstream bandwidth in the future. However, due to a PON network structure and mechanism, on the one hand, it is difficult to improve upstream receiving sensitivity of the OLT; on the other hand, an upstream is logically in a point-to-point relationship (the optical signal sent by the ONU is received only by the OLT), but 3.5*log₂^{N} dB is still lost by the splitter, that is, (N−1)/N of optical power is lost by the optical splitter. The PON system and the splitter in the prior art cannot reduce an upstream optical signal insertion loss or loss of an optical splitter, making it more difficult to increase bandwidth in the upstream direction.

### SUMMARY

Embodiments of the present invention provide an optical device and an optical module, so as to reduce an upstream optical signal insertion loss or loss.

According to a first aspect, an optical device is provided, including a spatial multiplexer/demultiplexer and an optical splitter, where the optical splitter is an M:N optical splitter, M is greater than or equal to 2, and N is greater than or equal to M, where M is a quantity of common ports of the optical splitter, and N is a quantity of drop ports of the optical splitter; and the spatial multiplexer/demultiplexer includes one common port and M drop ports, the M drop ports of the spatial multiplexer/demultiplexer are connected to M common ports of the optical splitter, and the common port of the spatial multiplexer/demultiplexer has a capability of transmitting optical signals in multiple spatial modes.

According to the first aspect, in a first possible implementation of the first aspect, the common port of the spatial multiplexer/demultiplexer is a multi-core fiber or a multi-core waveguide.

According to the first aspect, in a second possible implementation of the first aspect, the common port of the spatial multiplexer/demultiplexer is a few-mode fiber or a multi-mode fiber, or a few-mode waveguide or a multi-mode waveguide.

According to the first aspect, in a third possible implementation of the first aspect, the common port of the spatial multiplexer/demultiplexer is an orbital angular momentum OAM fiber or an OAM waveguide.

According to the first possible implementation of the first aspect, in a fourth possible implementation, each core in the multi-core fiber or the multi-core waveguide in the spatial multiplexer/demultiplexer corresponds to one spatial mode, the spatial multiplexer/demultiplexer is configured to multiplex an optical signal in one core to one of the M drop ports, or configured to multiplex an optical signal in one of the M drop ports to one core in the multi-core fiber or the multi-core waveguide.

According to the second possible implementation of the first aspect, in a fifth possible implementation, the common port of the spatial multiplexer/demultiplexer is capable of transmitting signals in multiple modes, the drop port is capable of transmitting only a fundamental mode signal, and the spatial multiplexer/demultiplexer demultiplexes, into multiple fundamental mode signals, optical signals in multiple modes in the common port and transmits the multiple fundamental mode signals to the M drop ports.

According to the third possible implementation of the first aspect, in a sixth possible implementation, the common port of the spatial multiplexer/demultiplexer is configured to transmit multiple OAM signals, and the spatial multiplexer/demultiplexer demultiplexes the multiple OAM signals to the M drop ports, where each OAM signal corresponds to one mode.

According to the second or the fifth possible implementation of the first aspect, in a seventh possible implementation, the multi-mode fiber or the few-mode fiber includes a first core, a second core, and a cladding, a diameter of the first core is less than a diameter of the second core, the diameter of the second core is less than a diameter of the cladding, a refractive index of the cladding is less than a refractive index of the second core, and the refractive index of the second core is less than a refractive index of the first core, where a fundamental mode optical signal LP01 is transmitted in the first core, and a high order mode optical signal is transmitted in the second core.

According to the second or the fifth possible implementation of the first aspect, in an eighth possible implementation, the multi-mode fiber or the few-mode fiber includes a first core, a second core, and a cladding, a refractive index of the second core is a graded refractive index, the refractive index of the second core is capable of grading from a minimum refractive index to a maximum refractive index in a curve form, a diameter of the first core is less than a diameter of the second core, the diameter of the second core is less than a diameter of the cladding, a refractive index of the cladding is less than a refractive index of the second core, and the refractive index of the second core is less than a refractive index of the first core.

According to a second aspect, an optical device is provided, including a spatial multiplexer/demultiplexer, one 1:N/2 first optical splitter, and N/2 2:2 second optical splitters, where the spatial multiplexer/demultiplexer has one common port and M drop ports, M is greater than or equal to 2, and M=N/2+1; a common port of the first optical splitter is connected to a first drop port of the spatial multiplexer/demultiplexer, and N/2 drop ports of the first optical splitter are respectively connected to first common ports of the N/2 2:2 optical splitters; and second common ports of the N/2 2:2 optical splitters are respectively connected to a second drop port to an (N/2+1)^{th} drop port of the spatial multiplexer/demultiplexer.

According to the second aspect, in a first possible implementation of the second aspect, when the spatial multiplexer/demultiplexer is a mode multiplexer, the common port is a few-mode fiber or a multi-mode fiber, or a few-mode waveguide or a multi-mode waveguide.

According to the first possible implementation of the second aspect, in a second possible implementation of the second aspect, the first drop port to an M^{th} drop port of the spatial multiplexer/demultiplexer are standard single-mode fibers or waveguides, and a mode of an optical signal transmitted in the single-mode fiber or waveguide is an LP01 mode; and an LP01 mode signal transmitted in the common port of the spatial multiplexer/demultiplexer is demultiplexed by the spatial multiplexer/demultiplexer to the first drop port of the spatial multiplexer/demultiplexer, and high order mode signals transmitted in the common port of the spatial multiplexer/demultiplexer are respectively demultiplexed by the spatial multiplexer/demultiplexer to the second to the M^{th} drop ports of the spatial multiplexer/demultiplexer.

According to the first or the second possible implementation of the second aspect, in a third possible implementation, the multi-mode fiber or the few-mode fiber includes a first core, a second core, and a cladding, a diameter of the first core is less than a diameter of the second core, the diameter of the second core is less than a diameter of the cladding, a refractive index of the cladding is less than a refractive index of the second core, and the refractive index of the second core is less than a refractive index of the first core, where a fundamental mode optical signal LP01 is transmitted in the first core, and a high order mode optical signal is transmitted in the second core.

According to the first possible implementation of the second aspect, in a fourth possible implementation, the multi-mode fiber or the few-mode fiber includes a first core, a second core, and a cladding, a refractive index of the second core is a graded refractive index, the refractive index of the second core is capable of grading from a minimum refractive index to a maximum refractive index in a curve form, a diameter of the first core is less than a diameter of the second core, the diameter of the second core is less than a diameter of the cladding, a refractive index of the cladding is less than a refractive index of the second core, and the refractive index of the second core is less than a refractive index of the first core.

According to a third aspect, an optical device is provided, including a spatial multiplexer/demultiplexer and N−1 2:2 optical splitters, N is greater than or equal to 2, the spatial multiplexer/demultiplexer has one common port and N drop ports, the N−1 2:2 optical splitters are connected in a permutation and combination manner to form an N:N optical splitter , and the permutation and combination manner includes one 2:2 optical splitter at a first stage, two 2:2 optical splitters at a second stage, and four 2:2 optical splitters at a third stage, where two common ports of the first-stage 2:2 optical splitter are respectively connected to a first drop port and a second drop port of the spatial multiplexer/demultiplexer; two drop ports of the first-stage 2:2 optical splitter are each connected to a first common port in two common ports of each of the two second-stage 2:2 optical splitter, and each drop port of the second-stage optical splitters is connected to a first common port in two common ports of a third-stage optical splitter; and second common ports of optical splitters at all the stages are connected to a third drop port to an N^{th} drop port of the spatial multiplexer/demultiplexer.

According to the third aspect, in a first possible implementation of the third aspect, when the spatial multiplexer/demultiplexer is a mode multiplexer, the common port of the spatial multiplexer/demultiplexer is a few-mode fiber or a multi-mode fiber, or a few-mode waveguide or a multi-mode waveguide.

According to the first possible implementation of the third aspect, in a second possible implementation of the third aspect, the drop ports of the spatial multiplexer/demultiplexer are standard single-mode fibers or single-mode waveguides, and a mode of an optical signal transmitted in the single-mode fiber or single-mode waveguide is an LP01 mode; and an LP01 mode signal transmitted in the common port of the spatial multiplexer/demultiplexer is demultiplexed by the spatial multiplexer/demultiplexer to the first drop port of the spatial multiplexer/demultiplexer, and high order mode signals transmitted in the common port of the spatial multiplexer/demultiplexer are respectively demultiplexed by the spatial multiplexer/demultiplexer to the second to the N^{th} drop ports of the spatial multiplexer/demultiplexer.

According to the first or the second possible implementation of the third aspect, in a third possible implementation of the third aspect, the multi-mode fiber or the few-mode fiber includes a first core, a second core, and a cladding, a diameter of the first core is less than a diameter of the second core, the diameter of the second core is less than a diameter of the cladding, a refractive index of the cladding is less than a refractive index of the second core, and the refractive index of the second core is less than a refractive index of the first core, where a fundamental mode optical signal LP01 is transmitted in the first core, and a high order mode optical signal is transmitted in the second core.

According to the first or the second possible implementation of the third aspect, in a fourth possible implementation of the third aspect, the multi-mode fiber or the few-mode fiber includes a first core, a second core, and a cladding, a refractive index of the second core is a graded refractive index, the refractive index of the second core is capable of grading from a minimum refractive index to a maximum refractive index in a curve form, a diameter of the first core is less than a diameter of the second core, the diameter of the second core is less than a diameter of the cladding, a refractive index of the cladding is less than a refractive index of the second core, and the refractive index of the second core is less than a refractive index of the first core.

According to a fourth aspect, a fiber is provided, where the fiber includes a first core, a second core, and a cladding, a diameter of the first core is less than a diameter of the second core, the diameter of the second core is less than a diameter of the cladding, a refractive index of the cladding is less than a refractive index of the second core, the refractive index of the second core is less than a refractive index of the first core, and in the fiber, a fundamental mode optical signal is transmitted in the first core, and a high order mode optical signal is transmitted in the second core.

With reference to the fourth aspect, in a first possible implementation of the fourth aspect, a spotsize of the fundamental mode optical signal in the fiber is basically the same as a spotsize in the single-mode fiber.

With reference to the fourth aspect or the first possible implementation of the fourth aspect, in a second possible implementation of the fourth aspect, the refractive index of the second core is capable of grading in a curve form.

According to a fifth aspect, an optical module is provided, where the optical module includes a transmitter optical subassembly TOSA, at least one receiver optical subassembly ROSA, a filter, a two-core fiber, a laser drive circuit, a received signal processing circuit, and a connector, where the two-core fiber is the fiber in the fourth aspect or any possible implementation of the fourth aspect.

With reference to the fifth aspect, in a first possible implementation of the fifth aspect, when the filter transmits an upstream wavelength and reflects a downstream wavelength, an optical signal sent by the TOSA is reflected by the filter, coupled to a first core in the two-core fiber, and sent in a fundamental mode; and a received upstream optical signal reaches the filter through the two-core fiber, reaches the ROSA through the filter, and is received by the ROSA.

With reference to the fifth aspect, in a second possible implementation of the fifth aspect, when the filter is a waveguide device, the filter has three ports, where a first port is connected to the two-core fiber, a second port is connected to the TOSA, and a third port is connected to the at least one ROSA; and an optical signal sent by the TOSA enters the filter through the second port of the filter, passes through a first core in the two-core fiber to which the first port of the filter is coupled, and is sent in a fundamental mode.

With reference to the fifth aspect or any possible implementation of the fifth aspect, in a third possible implementation of the fifth aspect, the upstream signal is one or a combination of a fundamental mode signal and a high order mode signal.

According to a sixth aspect, a PON system is provided, including an OLT and an ONU, where the OLT is connected to the ONU by using the optical device provided in the first aspect or any possible implementation of the first aspect, and an optical module of the OLT is the optical module in the fifth aspect or any possible implementation of the fifth aspect.

In the optical device, the optical module, and the PON system provided in the embodiments of the present invention, a space division fiber (the few-mode fiber or the multi-core fiber) or a space division waveguide compatible with an existing single-mode fiber is used to transfer an upstream optical signal to the optical module of the OLT in a space division manner, and a fiber in a cavity of a ceramic ferrule of the optical module of the OLT is also a space division fiber or a space division waveguide compatible with the existing single-mode fiber, so that the upstream optical signal is transferred in the space division manner to the receiver optical subassembly in the optical module of the OLT, thereby implementing a PON system having a low upstream insertion loss.

### BRIEF DESCRIPTION OF DRAWINGS

To describe the technical solutions in the embodiments of the present invention or in the prior art more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic structural diagram of an existing passive optical network PON system;

FIG. 2 is a schematic structural diagram of a 2:N splitting PON system according to the prior art;

FIG. 3 is a schematic structural diagram of an optical splitter according to the prior art;

FIG. 4 is a schematic structural diagram of an optical module according to the prior art;

FIG. 5 is a schematic structural diagram of an optical device according to an embodiment of the present invention;

FIG. 6 is a schematic structural diagram of an optical device according to another embodiment of the present invention;

FIG. 7 is a schematic structural diagram of an optical device according to another embodiment of this application;

FIG. 8 is a schematic structural diagram of an existing universal communications fiber;

FIG. 9 is a schematic diagram of a two-core step-index multi-mode or few-mode fiber according to an embodiment of the present invention;

FIG. 10 is a schematic diagram of a space division fiber or a space division waveguide according to an embodiment of the present invention;

FIG. 11 is a schematic diagram of an optical module of an OLT in a PON system that supports a low upstream insertion loss according to an embodiment of the present invention;

FIG. 12 is a schematic diagram of an optical module of an OLT in a PON system that supports a low upstream insertion loss according to another embodiment of the present invention;

FIG. 13 is a schematic diagram of an optical module of an OLT in a PON system that supports a low upstream insertion loss according to another embodiment of the present invention;

FIG. 14 is a schematic diagram of an optical module of an OLT in a PON system that supports a low upstream insertion loss according to still another embodiment of the present invention; and

FIG. 15 is a schematic structural diagram of a PON system having a low upstream insertion loss according to an embodiment of the present invention.

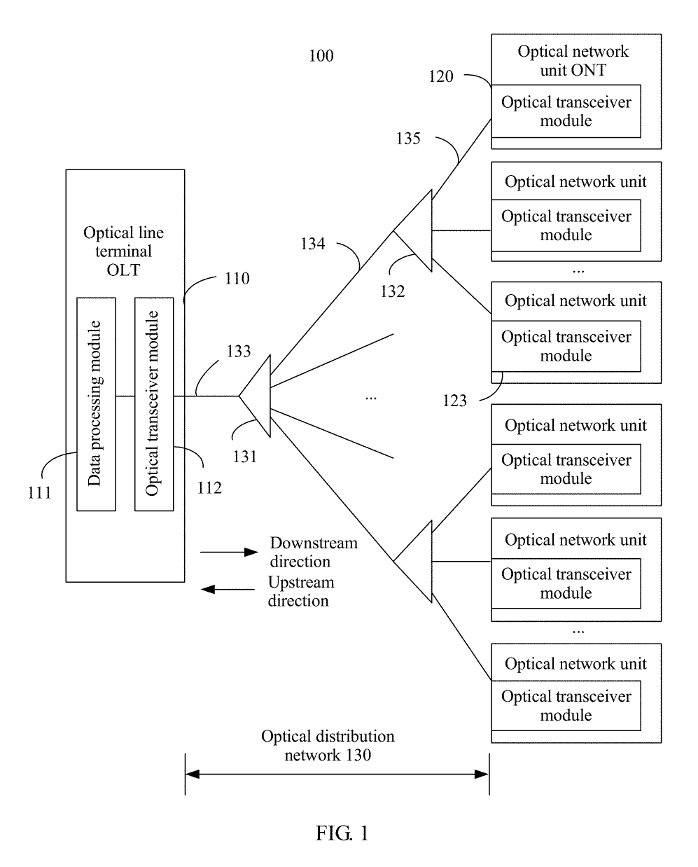

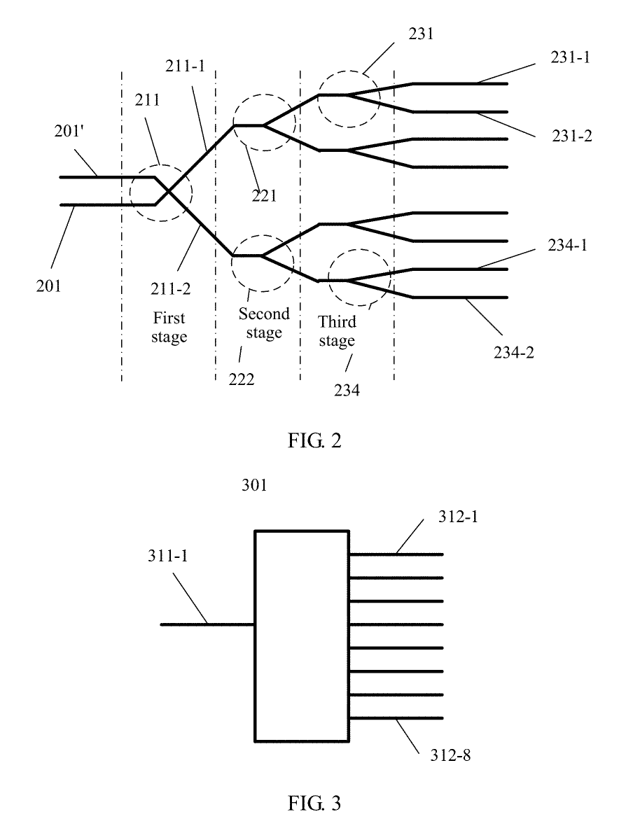

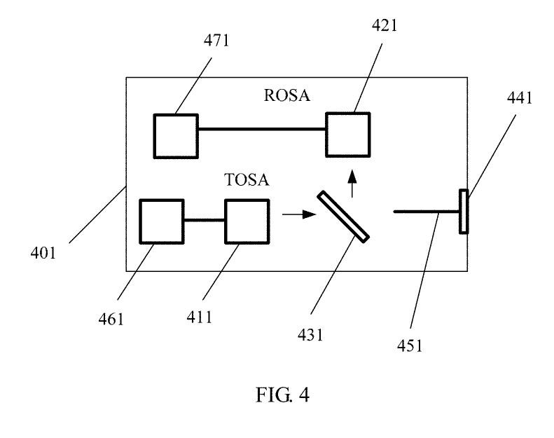

### DESCRIPTION OF EMBODIMENTS

The following clearly and describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

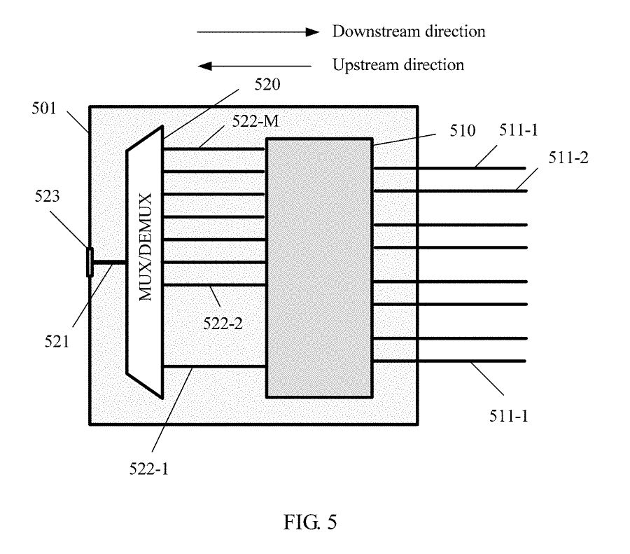

An optical device provided in an embodiment of this application is applicable to a point-to-multipoint optical network system. FIG. 5 is a schematic structural diagram of an optical device according to an embodiment of the present invention. The optical device 501 includes an optical splitter 510 (or referred to as a power splitter) and a spatial multiplexer/demultiplexer 520. The optical splitter 510 is an M:N optical splitter, M is greater than or equal to 2, and N is greater than or equal to M. M is a quantity of common ports of the optical splitter 510, and N is a quantity of drop ports of the optical splitter 510. As shown in FIG. 5, the common ports of the optical splitter 510 are 522-1, 522-2, , and 522-M, and the drop ports of the optical splitter 510 are 511-1, 511-2, . . . , and 511-N. A 1:N splitting relationship exists between a first common port 522-1 of the optical splitter 510 and the N drop ports of the optical splitter 510, that is, an optical signal that is input from the first common port 522-1 of the optical splitter 510 passes through the optical splitter 510 and reaches all the drop ports 511-1 to 511-N of the optical splitter 510, and an optical signal that is input from each of the drop ports 511-1 to 511-N of the optical splitter 510 passes through the first common port 522-1 of the optical splitter 510. An optical signal attenuation or insertion loss between the first common port 522-1 of the optical splitter 510 and each of the drop ports 511-1 to 511-N of the optical splitter 510 is approximately equal to 3*log₂^{N} decibels (dB) theoretically or is approximately equal to 3.5*log₂^{N} dB according to an empirical value. The 1:N relationship also exists between each of a second common port, a third common port, . . . , and an M^{th} common port 522-2 to 522-M of the optical splitter 510 and the N drop ports of the optical splitter 510. In this case, a theoretical insertion loss or attenuation between each of the second, the third, . . . , and the M^{th} common ports of the optical splitter 510 and the N drop ports of the optical splitter 510 is approximately equal to 3*log₂^{N} decibels or an insertion loss or attenuation calculated according to an empirical value is approximately equal to 3.5*log₂^{N} dB. In this case, an optical signal that is input from any common port can reach any drop port after undergoing an insertion loss of 3*log₂^{N} or 3.5*log₂^{N} dB. Alternatively, a 1:P relationship exists between each of the second, the third, . . . , and the M^{th} common ports 522-2, . . . , and 522-M of the optical splitter 510 and the N drop ports of the optical splitter 510, and P<N. Alternatively, the 1:N relationship may exist between the second common port 522-2 of the optical splitter 510 and the N drop ports of the optical splitter 510, the 1:P relationship may exist between each of the third to the M^{th} common ports 522-3 to 522-M and the N drop ports of the optical splitter 510, and P<N.

The spatial multiplexer/demultiplexer (SMD) 520 includes one common port 521 and M drop ports 522-1 to 522-M. The common port 521 has a capability of transmitting optical signals in multiple spatial modes. The M drop ports 522-1 to 522-M have a capability of transmitting an optical signal only in one spatial mode.

The common port 521 may be a multi-core (Multi-core) fiber or waveguide (Waveguide), or may be a few-mode (Few-Mode) or multi-mode (Multi-Mode) fiber or waveguide, or may be an orbital angular momentum (OAM) fiber or waveguide. When the common port 521 is a multi-core fiber or waveguide, each core (core) in the multi-core fiber or waveguide of the common port 521 corresponds to one spatial mode. The spatial multiplexer/demultiplexer demultiplexes an optical signal in one core to one drop fiber or waveguide 522-x, or multiplexes an optical signal in one drop fiber or waveguide 522-x to one core in the multi-core fiber or waveguide 521. Because the spatial multiplexer/demultiplexer 520 has the M drop ports, the common port 521 needs to be an M-core fiber (M-core fiber) or waveguide, or a multi-core fiber or waveguide that has more than M cores.

When the common port 521 is a few-mode or multi-mode fiber or waveguide, signals in multiple modes (Mode) (LP01, LP11, LP21, LP02 . . . ) can be transmitted in the common port 521, and the drop port 522-x (x=1 . . . M) can transmit only a fundamental mode signal (LP01). The spatial multiplexer/demultiplexer demultiplexes optical signals in multiple modes in the common port 521 into multiple fundamental mode signals and transmits the fundamental mode signals to the M drop ports 522-1 to 522-M, or converts fundamental mode signals received by the M drop ports into signals in multiple modes (LP01, LP11 . . . ) and multiplexes the signals to the common port 521. More specifically, a fundamental mode signal (LP01) in the common port 521 is demultiplexed by the spatial multiplexer/demultiplexer 520 to the drop port 522-1 and the fundamental mode signal (LP01) is also transmitted in the drop port 522-1, or a fundamental mode signal (LP01) transmitted in 522-1 is multiplexed by the spatial multiplexer/demultiplexer 520 to the LP01 mode of the common port 521. An LP11 or LP11a or LP11b signal in the common port 521 is demultiplexed by the spatial multiplexer/demultiplexer 520 into a fundamental mode signal (LP01) transmitted in the drop port 522-2, or a fundamental mode signal LP01 transmitted in 522-2 is multiplexed by the spatial multiplexer/demultiplexer 520 to the LP11 mode or the LP11a or LP11b mode of the common port 521, and so on. That is, after passing through the spatial multiplexer/demultiplexer 520, a fundamental mode (LP01) signal transmitted in the drop port 522-x (x=2 . . . M) is in a one-to-one correspondence with a high order mode (LP11 . . . ) in the common port 521. Because the spatial multiplexer/demultiplexer 520 has the M drop ports, the common port 521 needs to be a fiber or waveguide that can transmit signals in M or more modes.

When the common port 521 is an OAM fiber or waveguide, multiple OAM signals can be transmitted in the common port 521, and each OAM signal corresponds to one mode. The drop port 522-x (x=1 . . . M) is a single-mode fiber or waveguide. The spatial multiplexer/demultiplexer demultiplexes multiple OAM optical signals in the common port 521 to the M drop ports 522-1 to 522-M, or respectively converts optical signals received by the M drop ports into different OAM optical signals and multiplexes the OAM optical signals to the common port 521. Particularly, the spatial multiplexer/demultiplexer 520 does not change an optical signal mode of the first drop port 522-1, that is, a mode of an optical signal transmitted in the common port 521 is completely the same as that in the drop port 522-1, both of which are the same as a mode of an optical signal transmitted in a single-mode fiber or single-mode waveguide. Because the spatial multiplexer/demultiplexer 520 has the M drop ports, the common port 521 needs to be an OAM fiber or waveguide that can transmit signals in M or more modes.

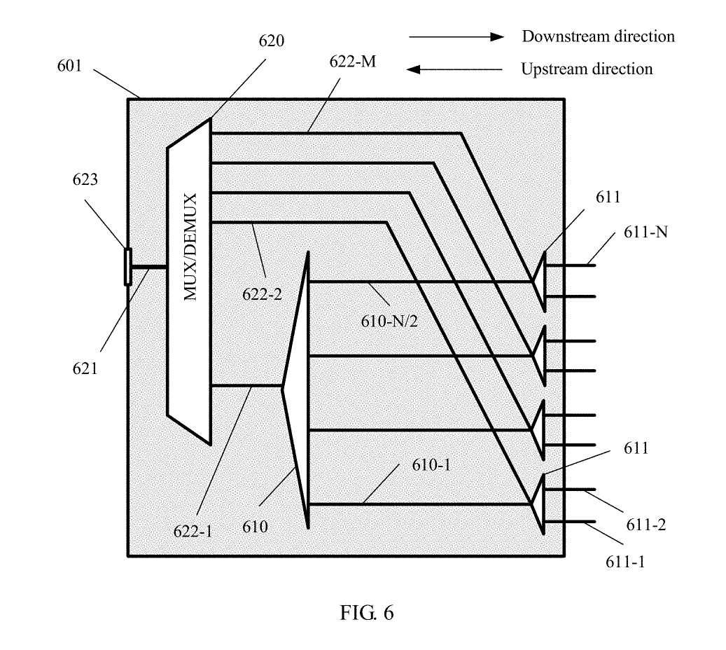

In a specific embodiment, as shown in FIG. 6, an optical device 601 includes a spatial multiplexer/demultiplexer 620, a first optical splitter 610, and a second optical splitter 611. The spatial multiplexer/demultiplexer 620 has one common port 621 and M drop ports 622-1 to 622-M. A split ratio of the optical splitter is 1:N, and the 1:N optical splitter includes one first optical splitter 610 that is a 1:N/2 optical splitter and N/2 second optical splitters 611 that are 2:2 optical splitters. M=N/2+1, and M is greater than or equal to 2. A common port of the 1:N/2 optical splitter 610 is connected to a first drop port 622-1 of the spatial multiplexer/demultiplexer 620. N/2 drop ports of the 1:N/2 optical splitter are respectively connected to first common ports 610-1 to 610-M of the 2:2 optical splitters 611. Second common ports of the N/2 2:2 optical splitters 611 are respectively connected to a second drop port to an (N/2+1)th (N/2+1 represents a sum of a number 1 plus N divided by 2) drop port 622-2 to 622-(N/2+1) of the spatial multiplexer/demultiplexer 620. Now, a mode multiplexing manner is used as an example to describe an operating principle of the optical device 601. A multiplexing manner for the multi-core fiber and an OAM multiplexing manner are similar thereto, and details are not described herein.

When the spatial multiplexer/demultiplexer 620 is a mode multiplexer, that is, a mode division multiplexing (MDM), the common port 621 of the spatial multiplexer/demultiplexer 620 is a few-mode fiber or a multi-mode fiber, or a few-mode waveguide or a multi-mode waveguide. The first drop port to an M^{th} drop port 622-1 to 622-M of the spatial multiplexer/demultiplexer are standard single-mode fibers (for example, G652) or waveguides. A mode of an optical signal transmitted in the single-mode fiber or waveguide is an LP01 mode. In a downstream direction or a left-to-right direction, an LP01 mode signal transmitted in the common port 621 of the spatial multiplexer/demultiplexer is demultiplexed by the spatial multiplexer/demultiplexer 620 to the first drop port 622-1 of the spatial multiplexer/demultiplexer 620, and high order mode (for example, LP11a, LP11b, LP02 . . . ) signals transmitted in the common port 621 of the spatial multiplexer/demultiplexer are respectively demultiplexed by the spatial multiplexer/demultiplexer 620 to the second to the M^{th} drop ports 622-2 to 622-M of the spatial multiplexer/demultiplexer. In an upstream direction or a right-to-left direction, an optical signal (LP01 mode optical signal) in the first drop port 622-1 of the spatial multiplexer/demultiplexer is converted by the spatial multiplexer/demultiplexer 620 into an LP01 mode optical signal in the common port 621 of the spatial multiplexer/demultiplexer, and optical signals in the second to the M^{th} drop ports 622-2 to 622-M of the spatial multiplexer/demultiplexer are respectively converted by the spatial multiplexer/demultiplexer 620 into high order mode optical signals in different modes in the common port 621 of the spatial multiplexer/demultiplexer (for example, a signal received from the second drop port 622-2 is converted into an LP11a mode optical signal, an optical signal received from the third drop port 622-3 is converted into an LP11b mode optical signal, and an optical signal received from the fourth drop port 622-4 is converted into an LP02 mode optical signal).

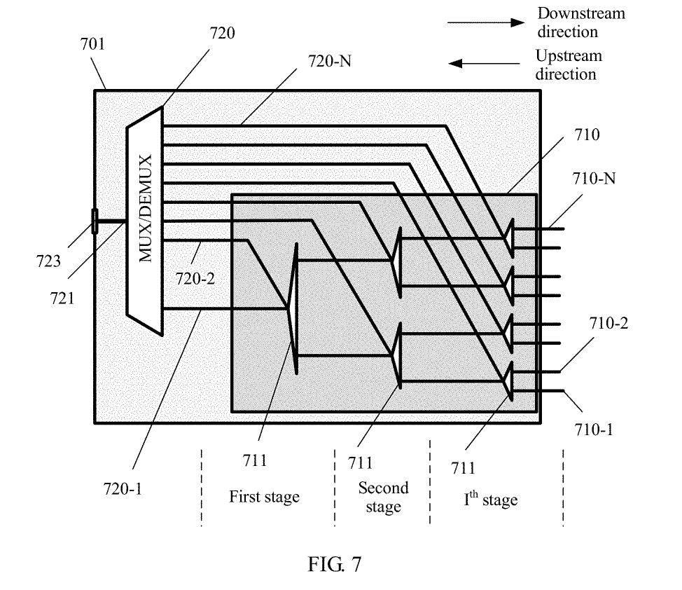

An embodiment of another optical device is shown in FIG. 7. The optical device 701 includes a spatial multiplexer/demultiplexer 720 and an N:N optical splitter 710. The spatial multiplexer/demultiplexer 720 has one common port 721 and N drop ports 622-1 to 622-N. A split ratio of the optical splitter 710 is N:N, and N is greater than or equal to 2. The N:N optical splitter 710 includes N−1 2:2 optical splitters 711. The N−1 2:2 optical splitters 711 are arranged and connected in a manner of 1, 2, 4, 8 . . . 2^{I-1} to form the N:N optical splitter 710. I=log2^{N}, and I is a quantity of stages of arrangement and connection of the N−1 2:2 optical splitters 711. In the arrangement and connection, there is one 2:2 optical splitter at a first stage, there are two 2:2 optical splitters at a second stage, there are four 2:2 optical splitters at a third stage, and the rest is deduced until an I^{th} stage. Two ports on a common end (or referred to as a feeder side) of the first-stage optical splitter are connected to a first drop port and a second drop port 720-1 and 720-2 of the spatial multiplexer/demultiplexer; two ports on a drop side (a right side in FIG. 7) of the first-stage optical splitter are each connected to one common port (temporarily referred to as a first common port) in two common ports of each of the two second-stage 2:2 optical splitters, and so on. Each drop port of a current-stage optical splitter is connected to one common port (temporarily referred to as a first common port) in two common ports of a next-stage 2:2 optical splitter. From the second stage to the I^{th} stage, the other common ports (temporarily referred to as second common ports) of all optical splitters are respectively connected to a third drop port to an N^{th} drop port of the spatial multiplexer/demultiplexer 720. Now, a mode multiplexing manner is used as an example to describe an operating principle of the optical device 701. A multiplexing manner for a multi-core fiber and an OAM multiplexing manner are similar thereto, and details are not described herein.

When the spatial multiplexer/demultiplexer 720 is a mode multiplexer, that is, a mode division multiplexing (MDM), the common port 721 of the spatial multiplexer/demultiplexer 720 is a few-mode fiber or a multi-mode fiber, or a few-mode waveguide or a multi-mode waveguide. The first to the Nth drop ports 720-1 to 720-N of the spatial multiplexer/demultiplexer are standard single-mode fibers (for example, G.652) or single-mode waveguides, or the first to the N^{th} drop ports 720-1 to 720-N of the spatial multiplexer/demultiplexer 720 are connected to single-mode fibers or single-mode waveguides. A mode of an optical signal transmitted in the single-mode fiber or waveguide is an LP01 mode. In a downstream direction or a left-to-right direction, an LP01 mode signal transmitted in the common port 721 of the spatial multiplexer/demultiplexer is demultiplexed by the spatial multiplexer/demultiplexer 720 to the first drop port 720-1 of the spatial multiplexer/demultiplexer, and high order mode (for example, LP11a, LP11b, LP02 . . . ) signals transmitted in the common port 721 of the spatial multiplexer/demultiplexer are respectively demultiplexed by the spatial multiplexer/demultiplexer 720 to the second to the Nth drop ports 720-2 to 720-N of the spatial multiplexer/demultiplexer 720. In an upstream direction or a right-to-left direction, an optical signal (LP01 mode optical signal) in the first drop port 720-1 of the spatial multiplexer/demultiplexer 720 is converted by the spatial multiplexer/demultiplexer 720 into an LP01 mode optical signal in the common port 721 of the spatial multiplexer/demultiplexer, and optical signals (LP01 mode optical signals) in the second to the N^{th} drop ports 720-2 to 720-N of the spatial multiplexer/demultiplexer are respectively converted by the spatial multiplexer/demultiplexer 720 into high order mode optical signals in different modes in the common port 721 of the spatial multiplexer/demultiplexer (for example, a signal received from the second drop port 720-2 is converted into an LP11a mode optical signal, an optical signal received from the third drop port 720-3 is converted into an LP11b mode optical signal, and an optical signal received from the fourth drop port 720-4 is converted into an LP02 mode optical signal).

A structure of an existing universal communications fiber is shown in

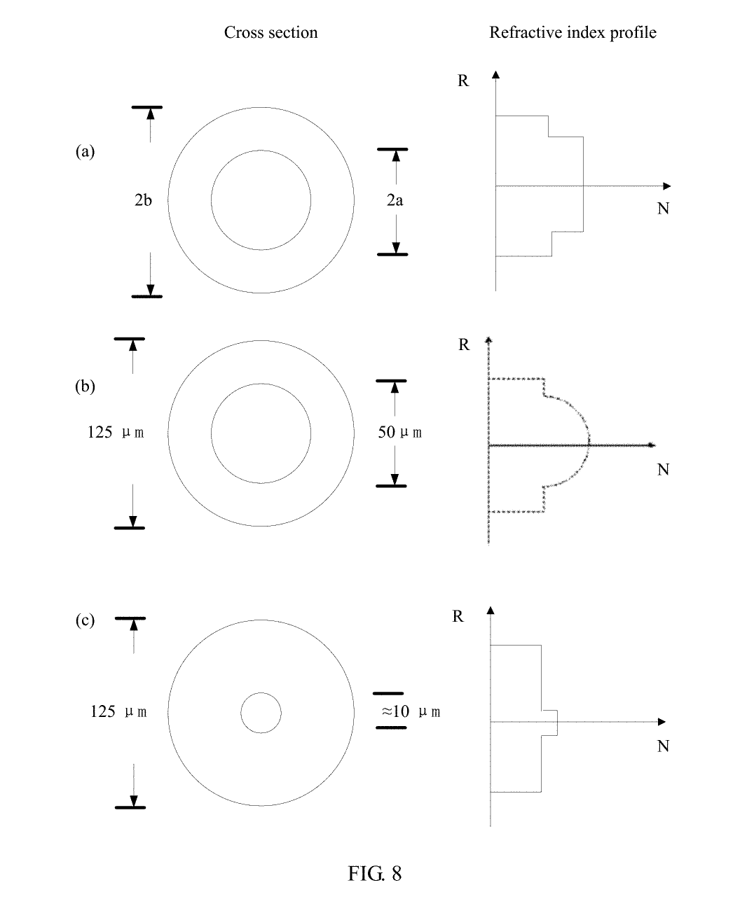

FIG. 8. FIG. 8(a) shows a step refractive index profile (step index for short) multi-mode fiber. A core of the fiber has a diameter of 2a, and a refractive index of n1. The fiber has a diameter of 2b (a diameter of a general multi-mode fiber is equal to 125 μm). A cladding has a refractive index of n2 (the refractive index of the cladding is less than the refractive index of the core, that is, n2<n1). FIG. 8(b) shows a refractive index profile of an existing graded-index multi-mode fiber. A core of the graded-index multi-mode fiber generally has a diameter of 50 um or 60 um, and the fiber generally has a diameter of 125 um. A cladding of the graded-index multi-mode fiber has a refractive index of n2. A refractive index of the core grades from a center point to the cladding, the core has a refractive index of n1 at a center, and a refractive index of n2 at an edge, and n2<n1. FIG. 8(c) shows a refractive index profile of an existing single-mode fiber. A core of the single-mode fiber generally has a diameter of approximately 10 um, and has a refractive index of n1. The fiber generally has a diameter of 125 um, a cladding has a refractive index of n2, and n2<n1. The core of the single-mode fiber can transmit a signal only in one mode, that is, can transmit only a fundamental mode (LP01) optical signal. Signals in multiple modes can be transmitted in cores of the existing graded-index and step-index multi-mode fibers (for a 1310 nm optical signal, generally, optical signals in dozens of modes can be transmitted), that is, in addition to the fundamental mode (LP01) optical signal, many high order mode optical signals can be further transmitted. When the existing multi-mode fiber is directly coupled to a single-mode fiber, when a fundamental mode signal in the multi-mode fiber is transmitted to the single-mode fiber, because a core diameter of the single-mode fiber is much less than a core diameter of the multi-mode fiber, fundamental mode spotsizes cannot match, causing a large loss or insertion loss.

For the problem of a relatively large fundamental mode (LP01) signal loss caused when the existing multi-mode fiber is coupled to the single-mode fiber, another embodiment of the present invention provides a two-core step-index multi-mode or few-mode fiber. This two-core step-index multi-mode or few-mode fiber includes a first core, a second core, and a cladding, as shown in FIG. 9. The first core has a diameter of 2x, and a refractive index of n1. The second core has a diameter of 2y, and a refractive index of n1′. The cladding has a diameter of approximately 125 um, and a refractive index of n2. The diameter of the first core is less than the diameter of the second core and less than the diameter of the cladding (or referred to as a fiber diameter), and the refractive index of the cladding is less than the refractive index of the second core and less than the refractive index of the first core, that is, 2x<2y and n2<n1′<n1. In the two-core step-index multi-mode or few-mode fiber, a fundamental mode optical signal (LP01) is transmitted in the first core, and a high order mode optical signal (LP11a, LP11b, LP02 . . . ) is transmitted in the second core. Further, a fundamental mode optical signal spotsize in the two-core step-index multi-mode or few-mode fiber is basically the same as a spotsize in a single-mode fiber. Alternatively, further, an insertion loss or loss caused when the two-core step-index multi-mode or few-mode fiber is coupled to a single-mode fiber is equivalent to a loss or insertion loss caused when one single-mode fiber is coupled to another single-mode fiber. The two-core step-index multi-mode or few-mode fiber not only can be used in a multi-mode fiber communications system or a few-mode fiber communications system, but also can be used in a single-mode fiber communications system.

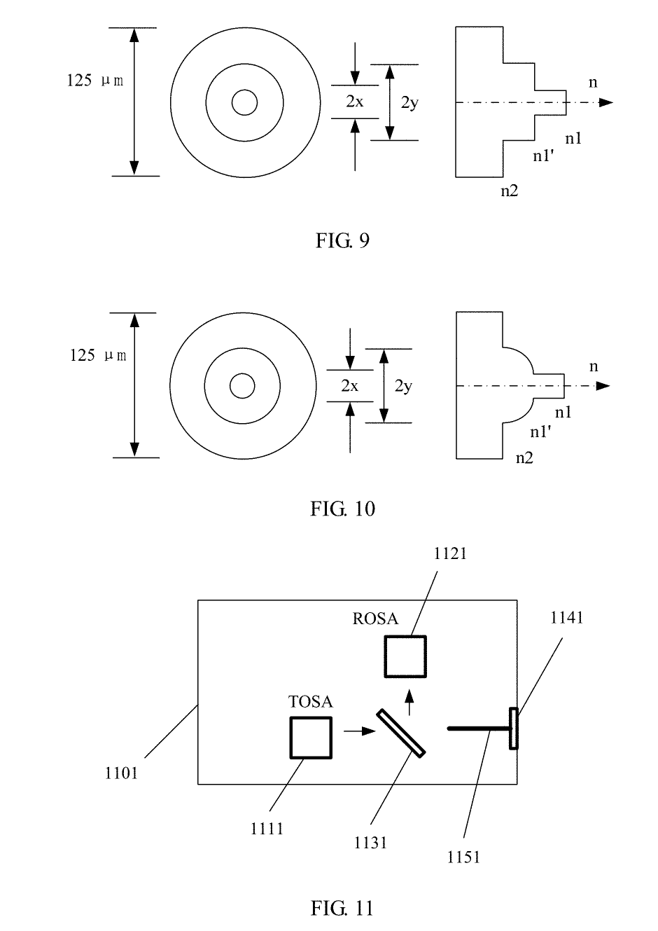

For the problem of a relatively large fundamental mode (LP01) signal loss caused when the existing multi-mode fiber is coupled to the single-mode fiber, the present invention provides a space division fiber or a space division waveguide. The space division fiber or waveguide is a two-core graded-index multi-mode or few-mode fiber, and this two-core graded-index multi-mode or few-mode fiber includes a first core, a second core, and a cladding, as shown in FIG. 10. The first core has a diameter of 2x, and a refractive index of n1. The second core has a diameter of 2y. A refractive index of the second core is a graded refractive index, a maximum refractive index is n1′, and a minimum refractive index is n1. The refractive index of the second core may grade from n1′ to n1 in a parabola, exponent, or any other curve form. The cladding has a diameter of approximately 125 um, and a refractive index of n2. The diameter of the first core is less than the diameter of the second core and less than the diameter of the cladding (or referred to as a fiber diameter), and the refractive index of the cladding is less than the refractive index of the second core and less than the refractive index of the first core, that is, 2x<2y and n2<n1′<n1. In the two-core graded-index multi-mode or few-mode fiber, a fundamental mode optical signal (LP01) is transmitted in the first core, and a high order mode optical signal (LP11a, LP11b, LP02 . . . ) is transmitted in the second core. Further, a fundamental mode optical signal spotsize in the two-core graded-index multi-mode or few-mode fiber matches a spotsize in a single-mode fiber. Alternatively, further, an insertion loss or loss caused when the two-core graded-index multi-mode or few-mode fiber is coupled to a single-mode fiber is equivalent to a loss or insertion loss caused when one single-mode fiber is coupled to another single-mode fiber. The two-core graded-index multi-mode or few-mode fiber not only can be used in a multi-mode fiber communications system or a few-mode fiber communications system, but also can be used in a single-mode fiber communications system.

In a specific embodiment, common ports of all optical devices described above are multi-mode fibers or waveguides, or few-mode fibers or waveguides.

In another specific embodiment, common ports of all optical devices described above are two-core step-index fibers or waveguides, or two-core graded-index fibers or waveguides.

The optical device provided in this embodiment of the present invention can reduce an upstream optical signal loss. A space division fiber (the few-mode fiber or the multi-core fiber) or a space division waveguide compatible with the existing single-mode fiber is used to transfer an upstream optical signal to an optical module of an OLT in a space division manner, and a fiber in a cavity of a ceramic ferrule of the optical module of the OLT is also a space division fiber or a space division waveguide compatible with the existing single-mode fiber, so that the upstream optical signal is transferred in the space division manner to a receiver optical subassembly in the optical module of the OLT, thereby implementing a PON system having a low upstream insertion loss.

An embodiment of the present invention further discloses an optical module. As shown in FIG. 11 to FIG. 13, the optical module includes a transmitter optical subassembly TOSA 1111, 1211, or 1311, a receiver optical subassembly ROSA 1121, 1221, or 1321, a filter (Wavelength Division Multiplexing Filter) 1131, 1231, or 1331, a two-core step-index or graded-index fiber or waveguide 1151, 1251, or 1351, a laser drive circuit (not shown in the figure), a received signal processing circuit (not shown in the figure), and a connector 1141, 1241, or 1341. The filter may also be referred to as a WDM reflector (WDM Reflector).

When a characteristic of the filter is reflecting an upstream wavelength and transmitting a downstream wavelength (for example, for a Gigabyte Passive Optical Network (GPON), 1310 nm is reflected, and 1490 nm is transmitted), an optical signal sent by the TOSA reaches the filter and passes through the filter, then is coupled to a first core of the two-core graded-index or step-index fiber or waveguide 1151, and is sent in a fundamental mode (LP01); a received upstream optical signal reaches the filter 1131 through the two-core graded-index or step-index fiber or waveguide 1151, is reflected by the filter 1131 to the ROSA 1121, and is received by the ROSA 1121. The ROSA 1121 converts the received optical signal into an electrical signal, and transmits the electrical signal to the subsequent received signal processing circuit. The upstream signal received by using the two-core graded-index or step-index fiber or waveguide 1151 may be one or a combination of a fundamental mode signal and a high order mode signal.

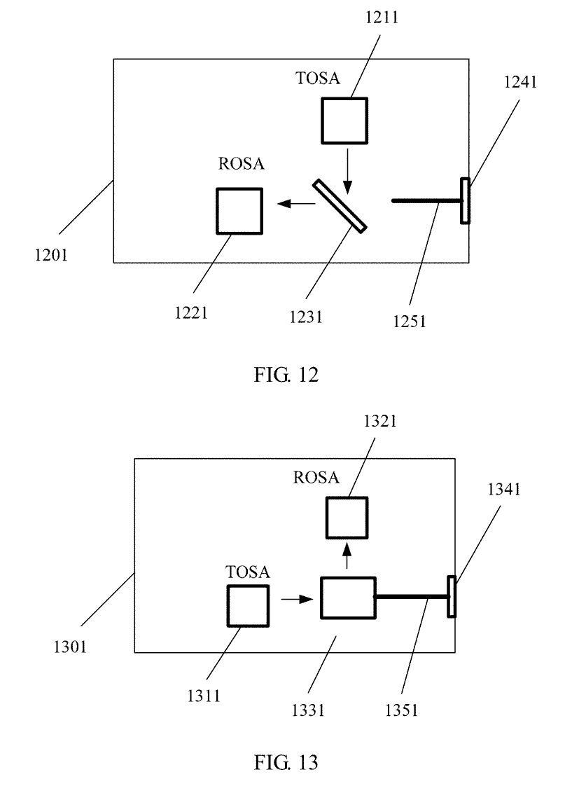

When a characteristic of the filter is transmitting an upstream wavelength and reflecting a downstream wavelength (for example, for a GPON, 1310 nm is transmitted, and 1490 nm is reflected), as shown in FIG. 12, an optical signal sent by the TOSA 1211 is reflected by the filter 1231, then coupled to a first core of the two-core graded-index or step-index fiber or waveguide 1251, and sent in a fundamental mode (LP01); a received upstream optical signal reaches the filter 1231 through the two-core graded-index or step-index fiber or waveguide 1251, is transmitted by the filter 1231 to the ROSA, and is received by the ROSA 1221. The ROSA 1221 converts the received optical signal into an electrical signal, and transmits the electrical signal to the subsequent received signal processing circuit. The upstream signal received by using the two-core graded-index or step-index fiber or waveguide 1251 may be one or a combination of a fundamental mode signal and a high order mode signal.

When the filter is a waveguide device, the filter 1331 has three ports. A first port is connected (or coupled) to the two-core graded-index or step-index fiber or waveguide 1351, a second port is connected (or coupled) to the TOSA 1311, and a third port is connected (or coupled) to the ROSA 1321, as shown in FIG. 13. An optical signal sent by the TOSA 1311 is coupled by the second port of the filter 1331 to the filter 1331, passes through the filter 1331, then is coupled by the first port to a first core in the two-core graded-index or step-index fiber or waveguide 1351, and is sent in a fundamental mode (LP01); a received upstream optical signal reaches the filter 1331 through the two-core graded-index or step-index fiber or waveguide 1351, reaches the ROSA through the third port of the filter 1331, and is received by the ROSA 1321. The ROSA 1321 converts the received optical signal into an electrical signal, and transmits the electrical signal to the subsequent received signal processing circuit. The upstream signal received by using the two-core graded-index or step-index fiber or waveguide 1351 may be one or a combination of a fundamental mode signal and a high order mode signal.

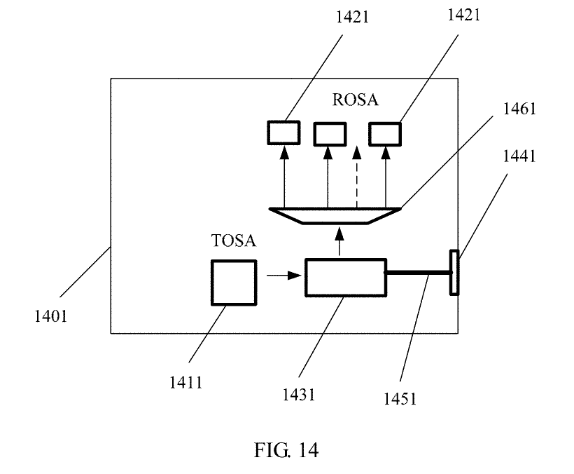

Another embodiment of the present invention provides an optical module. As shown in FIG. 14, the optical module includes a TOSA or laser 1411, multiple ROSAs or multiple photodiodes (Photodiode) or a photodiode array 1421, a filter (Wavelength Division Multiplexing Filter) 1431, a two-core step-index or graded-index fiber or waveguide 1451, a spatial multiplexer/demultiplexer 1461, a laser drive circuit (not shown in the figure), and a received signal processing circuit (not shown in the figure), and may further include a connector 1441. The filter 1431 has three ports. A first port is connected (or coupled) to the two-core graded-index or step-index fiber or waveguide 1451, a second port is connected (or coupled) to the TOSA or laser 1411, and a third port is connected (or coupled) to the multiple ROSAs or the multiple photodiodes or the photodiode array 1421. An optical signal sent by the TOSA 1411 is coupled by the second port of the filter 1431 to the filter 1431, passes through the filter 1431, then is coupled by the first port of the filter to a first core in the two-core graded-index or step-index fiber or waveguide 1451, and is sent in a fundamental mode (LP01). Received upstream optical signals reach the filter 1431 through the two-core graded-index or step-index fiber or waveguide 1451, and reach the spatial multiplexer/demultiplexer 1461 through the third port of the filter 1431, signals in different modes in the upstream optical signals are demultiplexed by the spatial multiplexer/demultiplexer 1461 to different ports of the spatial multiplexer/demultiplexer, and then received and converted by the multiple different ROSAs or the multiple photodiodes or the photodiode array 1421 into multiple electrical signals, and then the electrical signals are transmitted to the subsequent received signal processing circuit for processing.

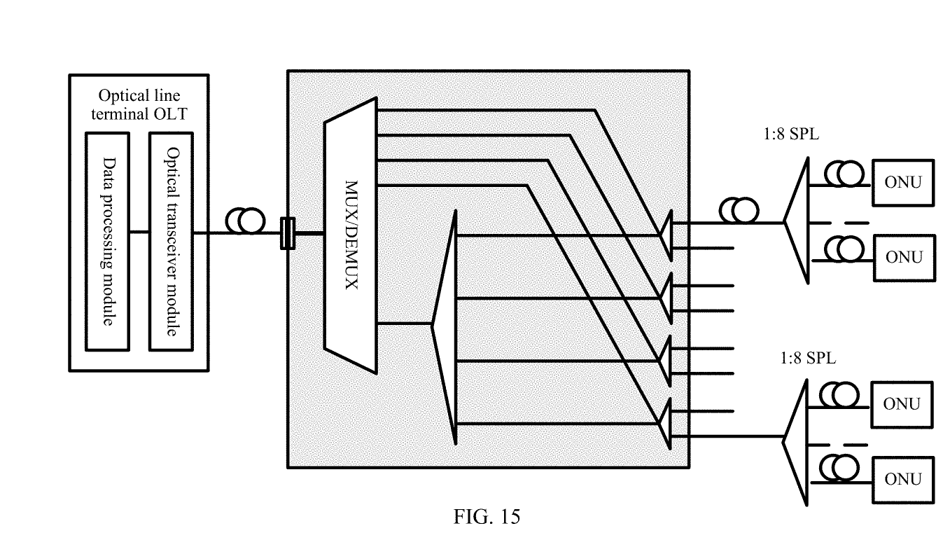

An embodiment of the present invention further provides a PON system having a low upstream insertion loss, as shown in FIG. 15. An OLT is connected to at least one ONU by using the optical device provided in the foregoing embodiment, and the OLT is internally provided with the optical module provided in the foregoing embodiment. In the PON system having a low upstream insertion loss provided in this embodiment of the present invention, a space division fiber (a few-mode fiber or a multi-core fiber) or a space division waveguide compatible with an existing single-mode fiber is used to transfer an upstream optical signal to the optical module of the OLT in a space division manner, and a fiber in a cavity of a ceramic ferrule of the optical module of the OLT is also a space division fiber or a space division waveguide compatible with the existing single-mode fiber, so that the upstream optical signal is transferred in the space division manner to a receiver optical subassembly in the optical module of the OLT, thereby implementing a PON system having a low upstream insertion loss.

The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. An optical device, comprising a spatial multiplexer/demultiplexer and an optical splitter, wherein
the optical splitter is an M:N optical splitter, M is an integer greater than or equal to 2, and N is greater than or equal to M, wherein M is a quantity of common ports of the optical splitter, and N is a quantity of drop ports of the optical splitter; and
the spatial multiplexer/demultiplexer comprises a common port and M drop ports, the M drop ports of the spatial multiplexer/demultiplexer are connected to the M common ports of the optical splitter, and the common port of the spatial multiplexer/demultiplexer has a capability of transmitting optical signals in multiple spatial modes.

2. The optical device according to claim 1, wherein the common port of the spatial multiplexer/demultiplexer is a multi-core fiber or a multi-core waveguide.

3. The optical device according to claim 2, wherein each core in the multi-core fiber or the multi-core waveguide in the spatial multiplexer/demultiplexer corresponds to one spatial mode, the spatial multiplexer/demultiplexer is configured to demultiplex an optical signal in one core of the multi-core fiber or the multi-core waveguide to one of the M drop ports, or configured to multiplex an optical signal in one of the M drop ports to one core in the multi-core fiber or the multi-core waveguide.

4. The optical device according to claim 1, wherein the common port of the spatial multiplexer/demultiplexer is a few-mode fiber, a multi-mode fiber, a few-mode waveguide, or a multi-mode waveguide.

5. The optical device according to claim 4, wherein the common port of the spatial multiplexer/demultiplexer is capable of transmitting optical signals in multiple modes, each of the M drop ports is capable of transmitting only a fundamental mode signal, and the spatial multiplexer/demultiplexer demultiplexes the optical signals in multiple modes in the common port into multiple fundamental mode signals, and transmits the multiple fundamental mode signals to the M drop ports.

6. The optical device according to claim 4, wherein the multi-mode fiber or the few-mode fiber comprises a first core, a second core, and a cladding, a diameter of the first core is less than a diameter of the second core, the diameter of the second core is less than a diameter of the cladding, a refractive index of the cladding is less than a refractive index of the second core, and the refractive index of the second core is less than a refractive index of the first core, wherein a fundamental-mode optical signal LP01 is transmitted in the first core, and a high-order-mode optical signal is transmitted in the second core.

7. The optical device according to claim 4, wherein the multi-mode fiber or the few-mode fiber comprises a first core, a second core, and a cladding, a refractive index of the second core is a graded refractive index, the refractive index of the second core is capable of grading from a small refractive index to a large refractive index in a curve form, a diameter of the first core is less than a diameter of the second core, the diameter of the second core is less than a diameter of the cladding, a refractive index of the cladding is less than a refractive index of the second core, and the refractive index of the second core is less than a refractive index of the first core.

8. The optical device according to claim 1, wherein the common port of the spatial multiplexer/demultiplexer is an orbital angular momentum (OAM) fiber or an OAM waveguide.

9. The optical device according to claim 8, wherein the common port of the spatial multiplexer/demultiplexer is configured to transmit multiple OAM signals, and the spatial multiplexer/demultiplexer demultiplexes the multiple OAM signals to the M drop ports, wherein each OAM signal corresponds to one mode.

10. A fiber, the fiber comprising a first core, a second core, and a cladding, a diameter of the first core is less than a diameter of the second core, the diameter of the second core is less than a diameter of the cladding, a refractive index of the cladding is less than a refractive index of the second core, the refractive index of the second core is less than a refractive index of the first core, a fundamental-mode optical signal is transmitted in the first core, and a high-order-mode optical signal is transmitted in the second core.

11. The fiber according to claim 10, wherein a spotsize of the fundamental-mode optical signal in the fiber is the same as a spotsize in a single-mode fiber.

12. The fiber according to claim 10, wherein the refractive index of the second core is capable of grading in a curve form.

13. An optical apparatus, the optical apparatus comprising a transmitter optical subassembly (TOSA), at least one receiver optical subassembly (ROSA), a two-core fiber, a laser drive circuit, a received signal processing circuit, and a connector, wherein the two-core fiber comprises a first core, a second core, and a cladding, wherein a diameter of the first core is less than a diameter of the second core, the diameter of the second core is less than a diameter of the cladding, a refractive index of the cladding is less than a refractive index of the second core, the refractive index of the second core is less than a refractive index of the first core, a fundamental-mode optical signal is transmitted in the first core, and a high-order-mode optical signal is transmitted in the second core.

14. The optical apparatus according to claim 13, wherein the optical apparatus comprises a filter.

15. The optical apparatus according to claim 14, wherein when the filter transmits an upstream wavelength and reflects a downstream wavelength, an optical signal from the TOSA is reflected by the filter, coupled to the first core in the two-core fiber, and sent in a fundamental mode; and a received upstream optical signal reaches the filter through the two-core fiber, and reaches the ROSA through the filter.

16. The optical apparatus according to claim 14, wherein when the filter is a waveguide device, the filter has three ports, wherein a first port is connected to the two-core fiber, a second port is connected to the TOSA, and a third port is connected to the at least one ROSA; and an optical signal sent by the TOSA enters the filter through the second port of the filter, passes through the first core in the two-core fiber to which the first port of the filter is coupled, and is sent in a fundamental mode.

17. The optical apparatus according to claim 15, wherein the received upstream optical signal is at least one of a fundamental-mode signal and a high-order-mode signal.
